(19) United States
(12) Patent Application Publication
(10) Pub. No.: US 2018/0234670 A1
(43) Pub. Date: Aug. 16, 2018

(54) DISPLAY DEVICE

(71) Applicant: Panasonic Intellectual Property Management Co., Ltd., Osaka (JP)

(72) Inventors: HIROSHI MITANI, Osaka (JP); KATSUO SAIGOU, Hyogo (JP); KENYA UOMORI, Osaka (JP)

(21) Appl. No.: 15/869,210

(22) Filed: Jan. 12, 2018

(30) Foreign Application Priority Data
Feb. 15, 2017 (JP) 2017-026243
Nov. 22, 2017 (JP) 2017-224651

(51) Int. Cl. H04N 13/00

(52) U.S. Cl. CPC H04N 13/0033; H04N 13/0018; H04N 13/0429

(57) ABSTRACT

The display device has a microdisplay, a mirror, and a three-dimensional renderer. The microdisplay has a display surface. A width of the display surface is narrower than a pupil distance between user's right and left pupils. The microdisplay is disposed so that a center of the display surface is equally distant from the right and the left pupils, and the display surface is directed toward a line of sight of the user. The mirror is located at a position at which the display image displayed on the display surface has one-time reflection so that the user views the virtual image symmetrically curved. The three-dimensional renderer processes an input signal and generates the display image to be displayed on the display surface so that when the user views the virtual image, the user accepts the virtual image as if the virtual image is displayed on a three-dimensional surface surrounding the user.

### BACKGROUND

### Technical Field

The present disclosure relates to a display device used by putting the user's head on.

### Description of the Related Art

Patent Literature 1 discloses a viewing device in which a light-emitting section of the television is located in the blind area of the viewer's eyes and image on the television is focused on the viewer's eyes by a concave mirror.

### CITATION LIST

### Patent Literature

PTL 1: Japanese Unexamined Patent Application Publication No. H01-133479

### SUMMARY

The present disclosure provides a display device capable of reducing stress caused by image distortion when the user views the image by binocular vision. Besides, the display device of the present disclosure is formed into a compact, light-weight structure.

The display device of the present disclosure is put on a user and displays a display image viewed by the user as a virtual image. The display device has a microdisplay, a mirror, and a three-dimensional renderer. The microdisplay has a display surface to display the display image. A width of the display surface is narrower than a pupil distance between user's right and left pupils. The microdisplay is disposed so that a center of the display surface is equally distant from the right and the left pupils, and the display surface is directed toward a line of sight of the user. The mirror is located at a position at which the display image displayed on the display surface of the microdisplay has one-time reflection so that the user views the virtual image symmetrically curved. The three-dimensional renderer processes an input signal and generates the display image to be displayed on the display surface of the microdisplay so that when the user views the virtual image of the display image via the mirror, the user accepts the virtual image as if the virtual image is displayed on a three-dimensional surface surrounding the user.

The display device of the present disclosure eases the user's stress caused by binocular vision with no need for increasing the length of light path to eliminate image distortion and no need for optical/electrical means to generate an individual image for each eye. Besides, employing a single display and a mirror allows the display device to be formed into a compact, lightweight structure at a low price.

### BRIEF DESCRIPTION OF DRAWINGS

FIG. 1 is a schematic view of the display device in accordance with a first exemplary embodiment.

FIG. 2 shows an image pattern that the microdisplay of the display device shows and the user's eyes view in accordance with the first exemplary embodiment.

FIG. 3A is a schematic view that shows a three-dimensional structure viewed by the user of the display device in accordance with the first exemplary embodiment.

FIG. 3B is schematic view that shows an image displayed on the microdisplay when the user virtually views the three-dimensional structure shown in FIG. 3A.

FIG. 4 is a schematic view that shows an image on the microdisplay with the display density changed by processing video signals.

FIG. 5 is a schematic view that shows an image on the microdisplay with the display density and brightness changed by processing video signals.

### DETAILED DESCRIPTION

Hereinafter, an exemplary embodiment will be described in detail, with reference to the accompanying drawings. However, details beyond necessity—for example, descriptions on well-known matters or on substantially identical structures—may be omitted to eliminate redundancy from the description below for easy understanding of those skilled in the art.

It is to be understood that the accompanying drawings and the description below are provided by the applicant for purposes of full understanding of those skilled in the art and are not to be construed as limitation on the scope of the claimed disclosure.

### First Exemplary Embodiment

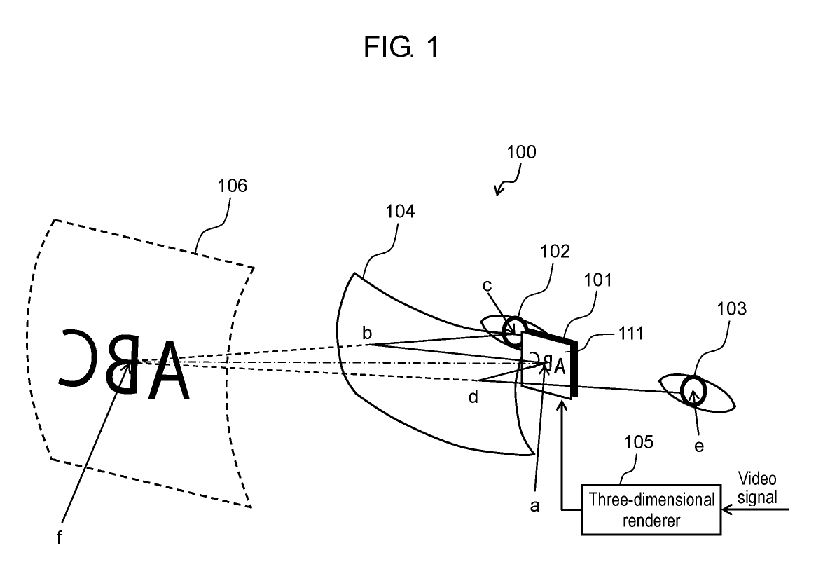

Hereinafter, the structure of the first exemplary embodiment will be described with reference to FIG. 1 through FIG. 3.

### [1-1. Structure]

FIG. 1 is a schematic view showing the display device of the first exemplary embodiment. Display device 100 has microdisplay 101, concave mirror 104, and three-dimensional renderer 105.

Microdisplay 101 is disposed right in front of user's eyes so as not to touch the face; specifically, it is located anterior to the midpoint of the line connecting between right pupil 102 and left pupil 103 of the user's eyes, with display surface 111 directed to the direction of the line of sight of the user. Microdisplay 101 has a width narrower than the pupil distance (i.e., the distance between right pupil 102 and left pupil 103 of the user's eyes) so as not to hinder vision ahead of the user. For example, the width of microdisplay 101 is determined to be narrower than the pupil distance of an adult male of average size. The dimensions other than the width are similarly determined.

Concave mirror 104 is disposed ahead microdisplay 101 in the direction of the line of sight of the user so as to be symmetrically positioned. The reflection surface of concave mirror 104, i.e., the concave surface is directed to the user. The video light emitted from point ‘a’ on microdisplay 101 has one-time reflection on the concave surface and then enters into right pupil 102 and left pupil 103 of the user's eyes, so that the image (display image) displayed in microdisplay 101 is reflected as a magnified image. Concave mirror 104 is an example of a mirror.

Further, concave mirror 104 has the curvature radius in the longitudinal direction slightly smaller than that in the lateral direction. The optical reflection surface of concave mirror 104 has a shape like a part cut out of a spheroid whose average curvature radius in the longitudinal direction and in the lateral direction belongs to the range from 95 mm to 150 mm That is, concave mirror 104 has a single, continuous curved surface, not having an individual reflection surface for each of the right and the left eyes of the user.

Receiving a video signal fed from outside, three-dimensional renderer 105 displays a display image corresponding to the video signal on display surface 111 of microdisplay 101. Three-dimensional renderer 105 processes the input video signal so as to provide the user with an easy-to-see image when the video signal fed from outside is mapped onto a three-dimensional surface. Three-dimensional renderer 105 is formed of a signal processing circuit, such as a microcomputer, an FPGA, and an ASIC. How three-dimensional renderer 105 processes video signals will be described later. The video signal is an example of an input signal and contains display information for the user.

With the structure above, the user views virtual image 106 ahead concave mirror 104 in the direction of the line of sight. Display device 100 of the embodiment has a fixed supporting member (not shown) that retains microdisplay 101 and concave mirror 104 at an intended position described above when the user uses the device. The supporting member of the display device is a head-worn type, for example, a head band, a helmet, a cap, a frame of eyeglasses, and a goggle. For example, the supporting member symmetrically retains concave mirror 104 and fixes each part of the device so that the central position of display surface 111 of microdisplay 101 faces the central position of the reflection surface of concave mirror 104.

### [1-2. Workings]

As shown in FIG. 1, the video light emitted from point ‘a’ on display surface 111 of microdisplay 101 reflects off concave mirror 104 at point ‘b’ of the reflection surface and enters into point ‘c’ of right pupil 102 of the user; at the same time, the video light emitted from point ‘a’ on display surface 111 of microdisplay 101 reflects off concave mirror 104 at point ‘d’ of the reflection surface and enters into point ‘e’ of left pupil 103 of the user. At that time, the user views virtual image 106 on intersection point T′ at which extended line segments c-b, e-d are intersected (i.e., the convergence point in binocular vision), and a convergence movement of both eyes occurs to form virtual image 106 onto the center of the retina.

Concave mirror 104 generates virtual image 106 as a mirror image, and therefore microdisplay 101 displays a mirror-reversed image in advance.

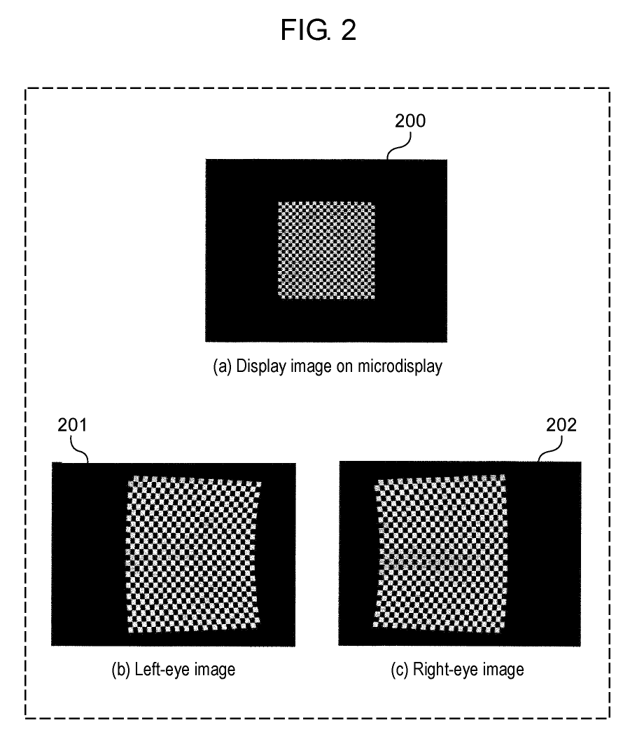

FIG. 2 illustrates an image perceived by the right and the left eyes of the user when microdisplay 101 displays display image 200 of a square checkered pattern. In display device 100 with the structure shown in FIG. 1, when microdisplay 101 displays display image 200 of a square checkered pattern shown in (a) of FIG. 2, the image is perceived by the user's eyes as a symmetrically curved image—the left eye receives it as left-eye image 201 shown in (b) of FIG. 2 whereas the right eye receives it as right-eye image 202 shown in (c) of FIG. 2.

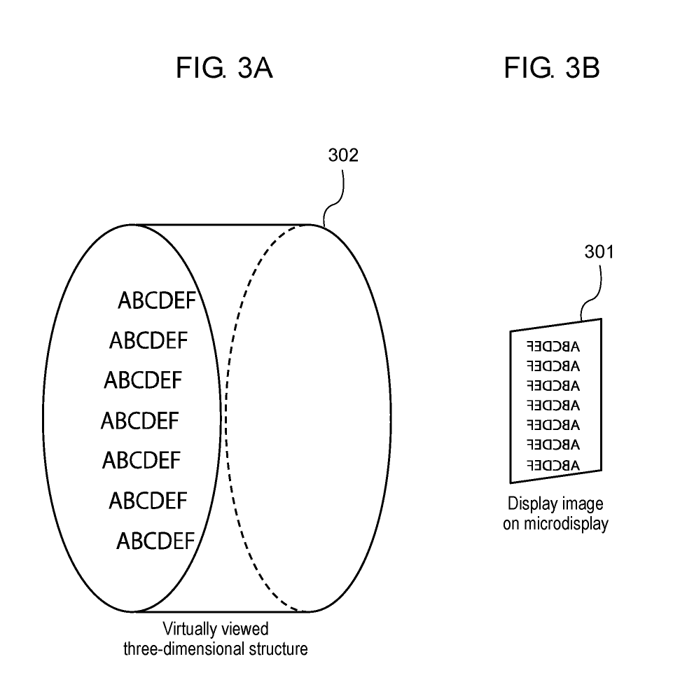

FIG. 3A and FIG. 3B schematically illustrate that the user virtually views three-dimensional structure 302 (FIG. 3A) when each of the right and the left eyes receives display image 301 on microdisplay 101a (FIG. 3B). When such a symmetrically curved image of an identical pattern shown in FIG. 2 is fused by binocular vision of the user, binocular parallax allows the user to perceive it as a three-dimensional image with setting back center and coming close top and bottom, although microdisplay 101 is flat. That is, the user views display image 301 on microdislplay 101 (FIG. 3B) as if it is attached to the inner surface of three-dimensional structure 302 surrounding the user (FIG. 3A). The three-dimensional image described here is a symmetrically curved virtual image, for example, three-dimensional structure 302 shown in FIG. 3A.

Three-dimensional renderer 105 shown in FIG. 1 processes the input video signal, allowing display image 301 to be easily seen by the user as if it is attached to the inner surface of three-dimensional structure 302; at the same time, allowing display image 301 to be seen by the user as a three-dimensional image with no contradiction.

As an example of processing input video signals, change in brightness (shading) is applied to the display image displayed on display surface 111 so that brightness defined to be the highest at the center of the display image gradually becomes lower toward the top and the bottom of the image. This coordinates with the three-dimensional image caused by binocular parallax. Further, the user feels like the center of the display image is positioned dead ahead. In consideration above, locating high-value data at the center of the image enhances effect of data layout. Further, adding a texture with a texture gradient (for example, display density and blurring) from the center toward the top and the bottom of the display image produces a similar effect.

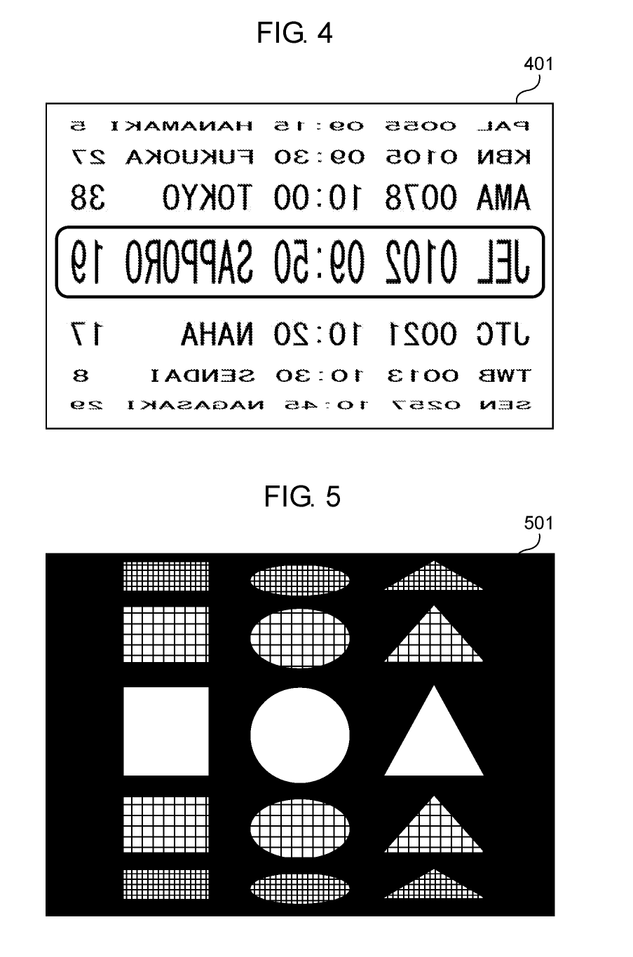

FIG. 4 schematically shows display image 401 on microdisplay 101, which has change in display density by processing video signals. In FIG. 4, the letters (text data) located in the central part of display image 401 are shown in the largest size in the vertical direction, and the size of letters becomes gradually smaller toward the top and the bottom, but in the longitudinal direction, all the letters are basically the same in size. That is, in the vertical direction, the central part has a small amount of information per unit area, i.e., the display density is low, and toward the top and the bottom, the amount of information per unit area becomes larger, i.e., the display density becomes higher. As described above, three-dimensional renderer 105 processes video signals so that the display density of display image 401 in the vertical direction becomes higher from the central part toward the top and the bottom of microdisplay 101. The signal processing allows the display image to be easily accepted as a three-dimensional image by user's binocular vision. In the description above, the letters (text data) are display information included in the video signals.

FIG. 5 schematically shows display image 501 on microdisplay 101, which has change in display density and brightness by processing video signals. In FIG. 5, the figures (graphic data) located in the central part of display image 501 are shown in the largest size in the vertical direction, and the size of the figures becomes gradually small toward the top and the bottom; at the same time, the central part of display image 501 is the highest in brightness, and the brightness becomes gradually lower toward the top and the bottom. That is, in the vertical direction, the contrast between the figures shown in the central part and the background is the strongest and it becomes gradually weaker toward the top and the bottom. As described above, three-dimensional renderer 105 processes video signals so that the contrast of display image 501 becomes gradually weaker toward the top and the bottom of microdisplay 101. The change in contrast provides the image with an out-of-focus effect gradually from the central part toward the top and the bottom, allowing the display image to be easily accepted as a three-dimensional image by user's binocular vision. In the description above, the figures (graphic data) are display information included in the video signals.

Further, the video-signal processing of three-dimensional renderer 105 may change definition of the display image so that the central part has high resolution while the peripheral part has low resolution. For example, in the central part, the display image may be controlled on the basis of one pixel of microdisplay 101, while the display image at the top and the bottom may be controlled on the basis of 4 pixels or 16 pixels. This allows the display image to have change in definition. As described above, the video-signal processing provides the display image with an out-of-focus effect from the central part toward the top and the bottom, allowing the display image to be easily accepted as a three-dimensional image by user's binocular vision.

Although the description above shows examples having changes in display density, brightness, and resolution in the vertical direction, it is not limited to; display density, brightness, and resolution may be horizontally changed or may be vertically and horizontally changed. That is, changing display density, brightness, and resolution from the center toward the periphery allows the display image to be easily accepted as a three-dimensional image by user's binocular vision.

When display density, brightness, and resolution of an image are changed either in the vertical direction or in the longitudinal direction, the direction in which the three-dimensional image to be displayed has a curvature radius smaller than the other should be selected.

### [1-3. Effect]

According to display device 100 of the first exemplary embodiment, binocular fusion of the user allows the display image displayed on flat display surface 111 of microdisplay 101 to be accepted as if it is a three-dimensional object. Further, to enhance the stereoscopic effect on the display image, three-dimensional renderer 105 processes video signals in advance, which allows the user to accept, without feeling of strangeness, the display image displayed on flat display surface 111 as a three-dimensional object. Further, providing display information to be displayed on flat display surface 111 with three-dimensional layout also enhances the stereoscopic effect.

For example, when the display image on microdisplay 101 is seen with one eye covered (i.e., seen with the right eye only or the left eye only), the user views a curved image there. However, display device 100 of the embodiment provides the display image with rendering so as to easily accept by both eyes the display image as a three-dimensional object. This smoothly brings binocular fusion, and the user virtually views a three-dimensional image (i.e., symmetrically curved virtual image) by binocular parallax.

Such structured display device 100 of the embodiment has no need for additionally employing a compensation device by which each of the right eye and the left eye views a distortion-free image, such as an optical component for compensating an optical distortion, and an optical shutter for giving an electrically-compensated image alternately to the right eye and the left eye.

As shown in FIG. 1, when the user views virtual image 106 by using display device 100, the line extended line segment c-b (corresponding to the optical axis of the right eye) and the line extended line segment e-d (corresponding to the optical axis of the left eye) intersect at point ‘f’, with no regard to difference in pupil distance between both eyes of a user.

If the optical axes of both eyes have no intersection at one point and have divergence at a great distance, the user will feel a sense of discomfort, since it never happens in everyday life as long as an object is seen with the naked eye. To remove such an uncomfortable feeling with no regard to difference in pupil distance between both eyes of a user, a head-worn type display device for binocular vision usually contains a position-control mechanism, for example, an electric circuit and a program-execution device by which the display positions for the right and the left eyes are controlled for difference in the pupil distance of users.

In contrast, display device 100 of the embodiment has no need for such a structure, and therefore it is formed into a simple structure. This allows the display device to be a lightweight, compact product with low cost.

Besides, according to display device 100 of the embodiment, the reflection surface of concave mirror 104 is a single continuous curved surface with no need of a complicated process and joint work. Therefore, display device 100 is applicable to a face-protection shield that has not been used as a display device.

### Other Exemplary Embodiments

As described above, the first exemplary embodiment has been described as an example of technique of the present disclosure. However, the technique of the present disclosure is not limited to the structure described above and is applicable to exemplary embodiments with various changes and modifications. Further, a combination of the components described in the first exemplary embodiment may form another structure other than the example described above. Hereinafter, other exemplary embodiments will be described.

Microdisplay 101 described in the first exemplary embodiment may be formed of a transmissive liquid crystal, a reflective liquid crystal, an LED array, organic EL, and electronic paper, as long as it has a width narrower than the pupil distance of the user's eyes and is disposed between concave mirror 104 and the user's face.

According to the description in the first exemplary embodiment, three-dimensional renderer 105 processes a video signal fed from the outside in real time, but it is not limited to; the process, which is performed in three-dimensional renderer 105 in the description above, may be applied in advance to the video signal and the video signal is directly fed to microdisplay 101.

According to the description in the first exemplary embodiment, microdisplay 101 is located, so as not to touch the face, anterior to the midpoint of the line connecting between right pupil 102 and left pupil 103 of the user toward the direction of the line of sight. However, if the image on concave mirror 104 has difference in size between the right-eye image and the left-eye image, it makes difficult for the user to obtain a fusion image by binocular vision. Therefore, as long as positioned with an equal distance from the right pupil 102 and left pupil 103 of the user, microdisplay 101 may be slightly shifted upward or downward so that the image on concave mirror 104 is almost the same in size for the right eye and the left eye.

Concave mirror 104 of the first exemplary embodiment may be a total-reflection type or may be semi-transparent so that the user enjoys both the display image and the landscape ahead. When concave mirror 104 is semi-transparent, the spectral characteristics of transmittance and/or reflectance may be flat; the mirror may selectively reflect or pass through a necessary wavelength; and transmittance and/or reflectance of the mirror may be different by part.

The reflection surface of concave mirror 104 of the first exemplary embodiment may be formed as the inner surface or the outer surface, and may be formed in the inside of concave mirror 104.

It will be understood that the aforementioned embodiment is merely an example of the technique of the present disclosure. That is, the technique of the present disclosure is not limited to the structure described above, allowing modification, replacement, addition, and omission without departing from the spirit and scope of the claimed disclosure.

### INDUSTRIAL APPLICABILITY

The present disclosure is applicable to a head-worn (i.e., hands-free) display device by which the user can get, while moving, various information, such as text data, picture data including drawings and photographs, and video data including motion pictures.

What is claimed is:

1. A display device that is put on a user and displays a display image viewed by the user as a virtual image, the display device comprising:
a microdisplay having a display surface to display the display image,
wherein a width of the display surface is narrower than a pupil distance between user's right and left pupils, and
wherein the microdisplay is disposed so that a center of the display surface is equally distant from the user's right and left pupils, and the display surface is directed toward a line of sight of the user;
a mirror located at a position at which the display image displayed on the display surface of the microdisplay has one-time reflection so that the user views the virtual image symmetrically curved; and
a three-dimensional renderer that processes an input signal and generates the display image to be displayed on the display surface of the microdisplay so that when the user views the virtual image of the display image via the mirror, the user accepts the virtual image as if the virtual image is displayed on a three-dimensional surface surrounding the user.

2. The display device according to claim 1, wherein the mirror is a concave mirror with a reflection surface of a spheroid shape.

3. The display device according to claim 1, wherein the three-dimensional renderer processes the input signal to change display density of the display image so that the display density is low in a central part of the display image while the display density is high in a peripheral part of the display image.

4. The display device according to claim 1, wherein the three-dimensional renderer processes the input signal to change brightness of the display image so that the brightness is high in a central part of the display image while the brightness is low in a peripheral part of the display image.

5. The display device according to claim 1, wherein the three-dimensional renderer processes the input signal to change definition of the display image so that resolution is high in a central part of the display image while the resolution is low in a peripheral part of the display image.
